(19) United States
(12) Patent Application Publication
(10) Pub. No.: US 2006/0196010 A1
(43) Pub. Date: Sep. 7, 2006

(54) Hinged mobile electronic device

(75) Inventor: Hsin-Ping Lin, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/364,087

(22) Filed: Mar. 1, 2006

(30) Foreign Application Priority Data
Mar. 2, 2005 (TW) 94106222

(51) Int. Cl. E05D 11/10

(52) U.S. Cl. 16/330; 16/221

(57) ABSTRACT

A hinged mobile electronic device. The hinged mobile electronic device comprises a body, a cover, a connecting portion, and a keyboard portion. The cover is hinged to the body between a first position and a second position. The connecting portion, connected between the body and the cover, comprises a control portion. The keyboard, disposed on the body, comprises a plurality of keys and an actuator connected to each key. When the cover hinges to the first position, the control portion exerts pressure on the actuator to actuate the keys. When the cover hinges to the second position, the control portion decompresses the actuator such that the keys become inoperative.

### BACKGROUND

The invention relates to an electronic device, and in particular to a hinged mobile electronic device.

Electronic devices such as mobile phones have become popular in daily use with designs thereof often symbolic of a user's lifestyle. Consumers demand both quality and appearance in electronic devices with increased functionality. Currently, popular types of mobile phone are hinged and non-hinged, with hinged types gaining popularity. A hinged-type mobile device comprise often comprise a body and a cover with the body comprising a plurality of keys, and the cover comprising a screen thereon. When the cover is closed, due to high closing speed, the cover often impacts the keys, which may be advertently actuated, causing execution of undesirable functions such as accidental calls being placed, with unwanted charges resulting.

### SUMMARY

The invention provides a hinged mobile electronic device, such that when a cover thereof is open, keys are operative, and when the cover is closed, the keys are inoperative, thus preventing accidental actuation of keys when closing the cover. Moreover, key sensitivity can be modified according to different demands.

Also provided is a hinged mobile electronic device comprising a body, a cover, a connecting portion, and a keyboard portion. The cover is connected to the body, hinging between a first position and a second position. The connecting portion, between the body and the cover, comprises a control portion. The keyboard, disposed on the body, comprises a plurality of keys and an actuator. The actuator is connected to each key. When the cover is in the first position, the control portion exerts pressure on the actuator to actuate the keys. When the cover hinges to the second position, the control portion decompresses the actuator such that the keys are inoperative.

The connecting portion further comprises a rotary shaft, connected to the control portion, with the body and the cover rotatably connected thereby.

The rotary shaft comprises a first cam, a second cam, and an elastic element. The first cam is connected to the cover. The second cam comprises an end movably contacting the first cam and another end connected to the control portion. The elastic element comprises an end connected to the body and another end penetrating the first cam and connected to the second cam. When the cover hinges with respect to the body, the second cam rotates with respect to the first cam and moves horizontally, thereby moving the control portion.

The elastic element comprises a spring.

Additionally, the control portion comprises a chamber and a piston, comprising an end connected to the chamber and another end connected to the second cam. When the cover hinges with respect to the body, the rotary shaft moves the piston. When the cover hinges to the first position, the second cam is moved accordingly with the piston pushed toward the chamber and exerting pressure thereon. When the cover hinges to the second position, the elastic element produces force on the second cam to withdraw the piston from the chamber, resulting in decompression thereof.

The actuator is partially hollow and communicates with the chamber. When the piston exerts pressure on the chamber, the actuator is pressurized. When the piston decompresses the chamber, the actuator is decompressed accordingly.

The chamber contains gas. When the cover hinges to the first position by rotation of the rotary shaft, gas is transferred from the chamber to the actuator such that the actuator is pressurized and becomes rigid; when the cover hinges to the second position, gas is exhausted from the actuator to the gas chamber such that the actuator is decompressed and loses rigidity. In this embodiment, the actuator comprises a pneumatic actuator.

In another embodiment, the chamber contains oil or fluid. When the cover is in the first position by rotation of the rotary shaft, oil or fluid is transferred from the chamber to the actuator such that the actuator is pressurized and becomes rigid. When the cover hinges to the second position, oil or fluid is withdrawn from the actuator to the chamber such that the actuator is decompressed and loses rigidity. In this embodiment, the actuator comprises a hydraulic actuator.

The actuator comprises a containing portion, and the keys comprise a plurality of hollow portions, connected to the containing portion.

The keyboard portion further comprises a printed circuit board, comprising a plurality of metal domes, each corresponding to a key, and the actuator is disposed between the keys and the metal domes.

### BRIEF DESCRIPTION OF THE DRAWINGS

The invention can be more fully understood by reading the subsequent detailed description in conjunction with the examples and references made to the accompanying drawings, wherein:

FIG. 1 is a perspective view of a hinged mobile electronic device of the invention;

FIG. 2 is a rear cross section of a hinged mobile electronic device of the invention in a first position;

FIG. 3 is a rear cross section of a hinged mobile electronic device of the invention in a second position;

FIG. 4 is a local enlarged view of a hinged mobile electronic device viewed from a cross section line AA′ of FIG. 2.

### DETAILED DESCRIPTION

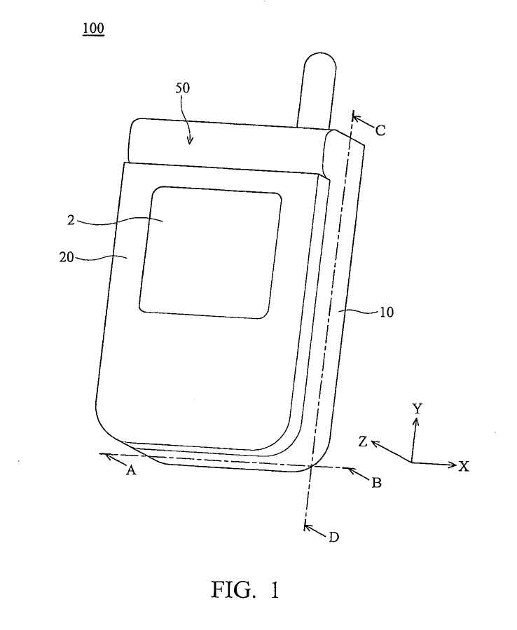

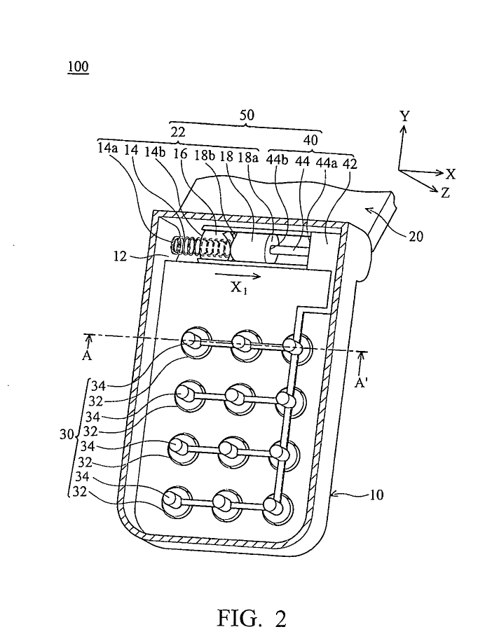

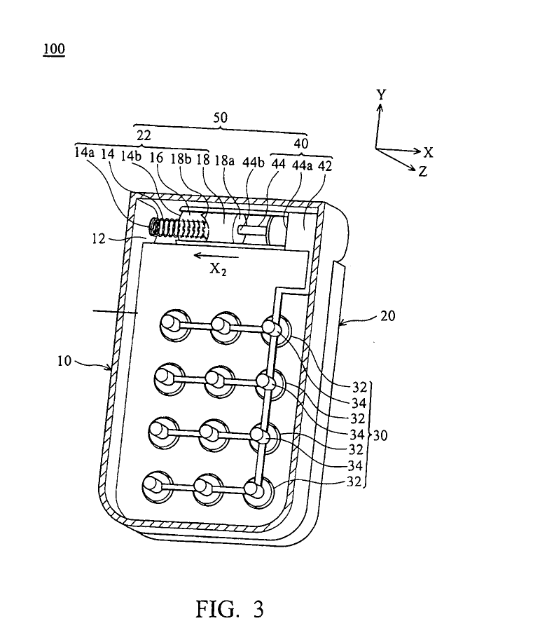

FIG. 1 is a perspective view of a hinged mobile electronic device 100 of the invention. FIG. 2 is a rear cross section of a hinged mobile electronic device 100 of the invention in a first position. FIG. 3 is a rear cross section of a hinged mobile electronic device 100 of the invention in a second position. As shown in FIG. 1, the hinged mobile electronic device 100 comprises a body 10 and a cover 20. The cover 20 comprises a panel 2. FIGS. 2 and 3 are views from cross section lines AB and CD of FIG. 1 for clear illustration of internal structures of the body 10. In a first position, the cover 20 is open, as shown in FIG. 2. In a second position, the cover 20 is closed, as shown in FIG. 3. Note that a hinged mobile phone is illustrated as an example. The hinged mobile electronic device 100 of the invention can be any electronic device with cover and keyboard.

As shown in FIGS. 2 and 3, the hinged mobile electronic device 100 comprises body 10, cover 20, a connecting portion 50, and the keyboard portion 30. The cover 20 is hinged the body 10, between the first position (FIG. 2) and the second position (FIG. 3). The connecting portion 50, between the body 10 and the cover 20, comprises a control portion 40 and a rotary shaft 22. The keyboard 30, disposed on the body 10, comprises a plurality of keys 32 and an actuator 34. The actuator 34 is connected to each key 32. When the cover 20 is in the first position, as shown in FIG. 2, the control portion 40 exerts pressure on the actuator 34 to actuate the keys 32 such that the keys 32 can be normally operated. When the cover 20 rotates to the second position, the control portion 40 decompresses the actuator 34 such that the keys 32 become inoperative. The rotary shaft 22 is connected to the control portion 40, and the body 10 and the cover 20 are hinged via the rotary shaft 22.

In detail, the rotary shaft 22 comprises a first cam 16, a second cam 18, and an elastic element 14. The first cam 16 is hollow and connected to a groove 12 of the cover 20. The second cam 18 comprises an end 18b movably contacting the first cam 16 and another end 18a connected to the control portion 40. The elastic element 14 can be a spring. The elastic element 14 comprises an end 14a connected to the body 10 and another end 14b passes through the first cam 16 and connected to the second cam 18. When the cover 20 rotates with respect to the body 10, the second cam 18 rotates with respect to the first cam 16 and moves horizontally in direction X₁, thereby moving the control portion 40. At the same time, the elastic element 14 is pulled due to the displacement of the second cam 18 and an elastic force is applied to the second cam 18 such that the second cam 18 maintains its position.

Additionally, the control portion 40 comprises a chamber 42 and a piston 44. The piston 44 comprises an end 44a connected to the chamber 42 and another end 44b connected to the second cam 18. When the cover 20 rotates with respect to the body 10, the rotary shaft 22 moves the piston 44 in direction X₁ or X₂. When the cover 20 is in the first position (FIG. 2), the second cam 18 is moved accordingly such that the piston 44 is pushed toward the chamber 42 and exerts pressure to the chamber 42. That is, the second cam 18 moves in direction X₁ to pressurize the chamber 42 by the piston 44.

When the cover 20 rotates to the second position (FIG. 3) and the cover 20 contacts the body 10, the elastic element 14 produces pulling force in direction X₂ such that the second cam 18 pulls the piston 44 away from the chamber 42 and decompresses the chamber 42.

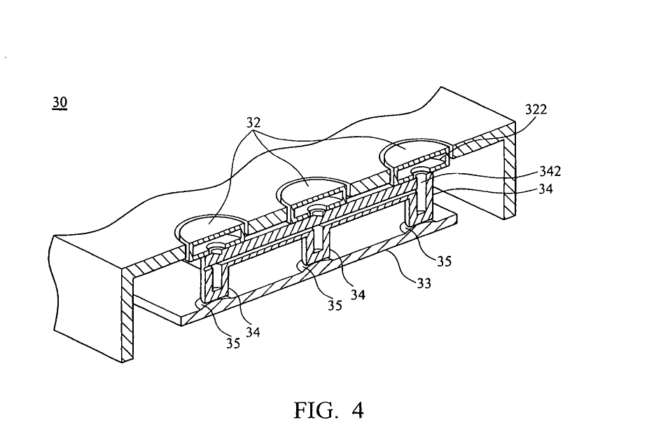

FIG. 4 is a local enlarged view of the hinged mobile electronic device 100 viewed from a cross section line AA′ of FIG. 2, showing a cross section of the keyboard portion 30. In FIG. 4, the actuator 34 is partially hollow, comprising a containing portion 342, to communicate with the chamber 42 of the control portion 40. The containing portion 342 contains gas or fluid. The keys 32 of the keyboard portion 30 comprise a plurality of hollow portions 322, connected to the containing portion 342 of the actuator 34. Hollow portion 322 can also contain gas or fluid. When the piston 44 exerts pressure on the chamber 42, the actuator 34 is pressurized. That is, when the containing portion 342 and the hollow portion 322 are filled with gas or fluid, the actuator 34 becomes rigid. When the piston 44 decompresses the chamber 42, the actuator 34 is decompressed accordingly. That is, when gas or fluid is withdrawn from the containing portion 342 and the hollow portion 322, the actuator 34 loses rigidity, as do the hollow portions 322 of the keys. Therefore, when the cover 20 is closed, the keys 32 are disabled to prevent accidental actuation. As shown in FIG. 4, the keyboard portion 30 further comprises a printed circuit board 33, comprising a plurality of metal domes 35 corresponding to keys 32, and the actuator 34 is disposed between the keys 32 and the metal domes 35. As described, when the containing portion 342 and the hollow portion 322 are filled with gas or fluid, the actuator 34 becomes rigid. When a key 32 is actuated, force from user can exert to the metal domes 35 via the keys 32 and the actuator 34. Therefore, the metal domes 35 on the printed circuit board 33 are actuated electrically. In this embodiment, the actuator 34 can be a pneumatic actuator, in which chamber 42 contains gas. When the cover 20 rotates to the first position (FIG. 2) by rotation of the rotary shaft 22, gas is transferred from the chamber 42 to the actuator 34 such that the actuator 34 is pressurized and becomes rigid. When the cover 20 rotates to the second position (FIG. 3), gas is exhausted from the actuator 34 to the chamber 42 such that the actuator 34 is decompressed and loses rigidity. Thus, the keys 32 are inoperative.

In some embodiments, the actuator 34 can be a hydraulic actuator, in which chamber 42 contains oil or fluid. When the cover 20 is in the first position (FIG. 2) by rotation of the rotary shaft 22, oil or fluid is transferred from the chamber 42 to the actuator 34 such that the actuator 34 is pressurized and becomes rigid. When the cover 20 hinges to the second position (FIG. 3), oil or fluid is withdrawn from the actuator 34 to the chamber 42 such that the actuator 34 is decompressed and loses rigidity.

In conclusion, the hinged mobile electronic device does not influence original functions thereof, but prevents accidental actuation of keys when closing the cover. Moreover, key sensitivity can be adjusted by changing the amount of gas or fluid from the piston to the chamber. Thus, resistance and height of keys can be preset for different key sensitivity demands.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hinged mobile electronic device, comprising:
a body;
a cover, hinged to the body, the cover rotatable between a first position and a second position;
a connecting portion, connected between the body and the cover, the connecting portion comprising a control portion; and
a keyboard portion, disposed on the body, the keyboard portion comprising a plurality of keys and an actuator connected to each key;
wherein when the cover is at the first position, the control portion exerts pressure on the actuator to actuate the keys; and when the cover is at the second position, the control portion decompresses the actuator such that the keys are inoperative.

2. The hinged mobile electronic device as claimed in claim 1, wherein the connecting portion further comprises a rotary shaft connected to the control portion, and the body and the cover are hinged via the rotary shaft.

3. The hinged mobile electronic device as claimed in claim 2, wherein the rotary shaft comprises:
a first cam, connected to the cover;
a second cam, comprising two ends, wherein one end movably contacting the first cam and the other end connected to the control portion; and
an elastic element comprising two ends, wherein one end connected to the body and the other end connected to the second cam through the first cam, wherein when the cover rotates with respect to the body, the second cam rotates with respect to the first cam and moves horizontally, thereby moving the control portion.

4. The hinged mobile electronic device as claimed in claim 3, wherein the elastic element comprises a spring.

5. The hinged mobile electronic device as claimed in claim 2, wherein the control portion comprises:
a chamber; and
a piston, comprising two ends, wherein one end connected to the chamber and the other end connected to the second cam, wherein when the cover rotates with respect to the body, the rotary shaft moves the piston; and when the cover is at the first position, the second cam moves the piston toward the chamber and puts pressure to the chamber; and when the cover is at the second position, the elastic element produces force such that the second cam pulls the piston away from the chamber and decompresses the chamber.

6. The hinged mobile electronic device as claimed in claim 5, wherein the actuator is at least partially hollow and communicates with the chamber, and when the piston exerts pressure on the chamber, the actuator is pressurized; and when the piston decompresses the chamber, the actuator is decompressed accordingly.

7. The hinged mobile electronic device as claimed in claim 5, wherein the chamber is to contain gas; whereby when the cover hinges to the first position by rotation of the rotary shaft, gas is transferred from the chamber to the actuator such that the actuator is pressurized and becomes rigid; and when the cover hinges to the second position, gas is exhausted from the actuator to the chamber such that the actuator is decompressed and loses rigidity.

8. The hinged mobile electronic device as claimed in claim 7, wherein the actuator comprises a pneumatic actuator.

9. The hinged mobile electronic device as claimed in claim 5, wherein the chamber is to contain oil or fluid; whereby when the cover is in the first position by rotation of the rotary shaft, oil or fluid is transferred from the chamber to the actuator such that the actuator is pressurized and becomes rigid; and when the cover hinges to the second position, oil or fluid is withdrawn from the actuator to the chamber such that the actuator is decompressed and loses rigidity.

10. The hinged mobile electronic device as claimed in claim 9, wherein the actuator comprises a hydraulic actuator.

11. The hinged mobile electronic device as claimed in claim 1, wherein the actuator comprises a containing portion, and the keys comprises a plurality of hollow portions connected to the containing portion.

12. The hinged mobile electronic device as claimed in claim 1, wherein the keyboard portion further comprises a printed circuit board, the printed circuit board comprising a plurality of metal domes corresponding to the keys, and the actuator is disposed between the keys and the metal domes.
